(19) United States
(12) Patent Application Publication
(10) Pub. No.: US 2015/0251339 A1
(43) Pub. Date: Sep. 10, 2015

(54) Template Substrate, Template, and Method of Fabricating Template Substrate

(71) Applicant: Kabushiki Kaisha Toshiba, Tokyo (JP)

(72) Inventor: Yohko FURUTONO, Yokohama-shi (JP)

(21) Appl. No.: 14/335,275

(22) Filed: Jul. 18, 2014

(30) Foreign Application Priority Data
Mar. 10, 2014 (JP) 2014-045997

(51) Int. Cl. B29C 33/38; B29C 33/56

(52) U.S. Cl. CPC B29C 33/3842; B29C 33/56; B29K 2995/0026

(57) ABSTRACT

A template substrate of an embodiment is provided with a substrate portion and a covering portion. The substrate portion is formed of a first light transmitting material. The substrate portion includes a first surface on which a template pattern transferred by imprint is formed and a second surface on a surface side opposed to the first surface on which predetermined work is performed. The covering portion covers at least a part of the second surface with the second light transmitting material.

### CROSS-REFERENCE TO RELATED APPLICATIONS

This application is based upon and claims the benefit of priority from Japanese Patent Application No. 2014-045997, filed on Mar. 10, 2014; the entire contents of which are incorporated herein by reference.

### FIELD

An embodiment relates to a template substrate, a template, and a method of fabricating a template substrate.

### BACKGROUND

In a process of manufacturing a semiconductor device, an imprinting method to transfer a mold of an original plate (template) to a transferred substrate attracts attention as technology to satisfy formation of a fine pattern of 100 nm or finer and a mass production property. The imprinting method is a method of bringing the template on which a pattern to be transferred is formed into contact with a resist layer applied to the transferred substrate and curing the resist layer after a groove of the template is sufficiently filled with the resist, thereby transferring the pattern to the resist layer.

In such imprinting method, a defect of the template is directly transferred to the transferred substrate, so that defect inspection of the template is important. However, when there is a scratch on a rear surface of the template, inspection light is irregularly reflected by the scratch on the rear surface, so that defect inspection accuracy is problematically deteriorated.

In the template used in the imprinting method, a template material in a pattern forming portion is worked to be thin so as to shorten fill time of the resist. In order to make the template material thin, the working is performed from a rear surface side of the pattern forming portion. At that time, the scratch easily occurs on the rear surface of the pattern forming portion. As a result, the template cannot be inspected with a high degree of accuracy due to rear surface working of the pattern forming portion. Therefore, it is desired to develop the template with which the defect inspection may be performed with a high degree of accuracy.

### BRIEF DESCRIPTION OF THE DRAWINGS

FIG. 1 is a view of a configuration of an imprinting device;

FIG. 2 is a view for illustrating a method of forming a template substrate;

FIGS. 3A to 3D are views of cross-sectional configuration examples of template substrates according to an embodiment;

FIGS. 4A to 4D are views of cross-sectional configuration examples of templates according to the embodiment including a mesa portion;

FIGS. 5A to 5D are views of cross-sectional configuration examples of the templates according to the embodiment without the mesa portion;

FIG. 6 is a view of a first fabricating procedure of the template;

FIG. 7 is a view of a second fabricating procedure of the template;

FIG. 8 is a view of a third fabricating procedure of the template;

FIG. 9 is a view of a fourth fabricating procedure of the template;

FIG. 10 is a view of a fifth fabricating procedure of the template; and

FIG. 11 is a view of a procedure when a light transmitting material is removed from the template.

### DETAILED DESCRIPTION

According to an embodiment, a template substrate is provided. The template substrate is provided with a substrate portion and a covering portion. The substrate portion is formed of a first light transmitting material. The substrate portion includes a first surface on which a template pattern transferred by imprint is formed and a second surface on a surface side opposed to the first surface on which predetermined working is performed. The covering portion covers at least a part of the second surface with a second light transmitting material.

A template substrate, a template, and a method of fabricating a template substrate according to an embodiment are hereinafter described in detail with reference to the attached drawings. Meanwhile, the present invention is not limited by the embodiment.

### Embodiment

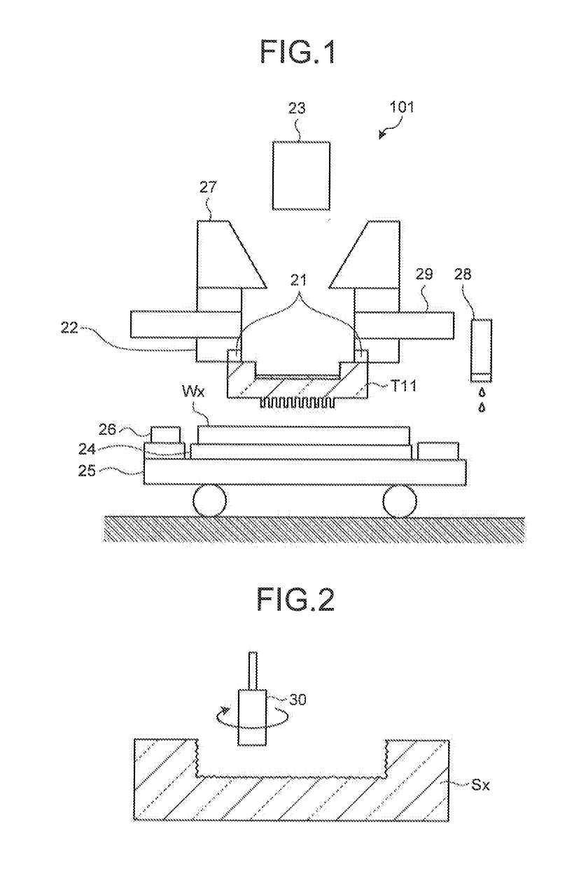

FIG. 1 is a view of a configuration of an imprinting device. An imprinting device 101 is a device which transfers a template pattern (circuit pattern and the like) of a template (imprint mold) T11 being a mold substrate to a transferred substrate such as a wafer Wx.

The imprinting device 101 is provided with an original plate stage 22, a UV light source 23, a substrate chuck 24, a sample stage 25, a reference mark 26, an alignment sensor 27, a liquid dropping device 28, and a stage base 29.

The sample stage 25 on which the wafer Wx is put moves in a plane (horizontal plane) parallel to the put wafer Wx. The sample stage 25 moves the wafer Wx to a side below the liquid dropping device 28 when a resist (imprint resist) as a transfer material is dropped on the wafer Wx and moves the wafer Wx to a side below the template T11 when a pressing process is performed on the wafer Wx.

The substrate chuck 24 is provided on the sample stage 25. The substrate chuck 24 fixes the wafer Wx in a predetermined position on the sample stage 25. The reference mark 26 is provided on the sample stage 25. The reference mark 26 is a stark for detecting a position of the sample stage 25 and is used in position adjustment when the wafer Wx is loaded on the sample stage 25.

The original plate stage 22 is provided on a bottom surface side (wafer Wx side) of the stage base 29. The original plate stage 22 includes a vacuum chuck 21 which vacuum-sucks the template T11. The vacuum chuck 21 fixes the template T11 in a predetermined position by vacuum-sucking the same from a rear surface side (surface on a side on which the template pattern is not formed) of the template T11. The vacuum chuck 21 vacuum-sucks a vacuum-sucked area to be described later of the template T11.

The stage base 29 supports the template T11 by the original plate stage 22 and presses a side of the template pattern of the template T11 against the resist on the wafer Wx. The stage base 29 moves, in an up-and-down direction (vertical direction), thereby pressing the template T11 against the resist and separating (releasing) the template T11 from the resist. The resist used in imprint is a resin (organic material) having a light-curing property and the like, for example. The alignment sensor 27 is provided on the stage base 29. The alignment sensor 27 is a sensor which detects a position of the wafer Wx and detects a position of the template T11.

The liquid dropping device 28 is a device which drops the resist on the wafer Wx by an inkjet method. The UV light source 23 is a light source which applies UV light provided above the stage base 29. The UV light source 23 applies the UV light above the template T11 in a state in which the template T11 is pressed against the resist.

A procedure of an imprinting process is herein described. When the imprint is performed on the wafer Wx, the wafer Wx put on the sample stage 25 is moved to a position immediately below the liquid dropping device 28. Then, the resist is dropped above a predetermined shot position of the wafer Wx. At that time, the liquid dropping device 28 drops the resist on a predetermined resist arrangement position.

Thereafter, the wafer Wx on the sample stage 25 is moved to a position immediately below the template T11. Then, the template T11 is pressed against the resist on the wafer Wx. When the template T11 formed by cutting the template substrate such as a quartz substrate (blank) is pressed against the resist, the resist flows into the template pattern of the template T11 by capillary action.

When the template T11 is pressed against the resist on the wafer Wx for a preset time period, the resist is spread on the wafer Wx to fill the template pattern. In this state, the UV light source 23 applies the UV light to the resist to cure the same. Then, the template T11 is released from the cured resist and a resist pattern obtained by inverting the template pattern is formed (patterned) on the wafer Wx. Thereafter, the imprinting process is performed on a next shot

Next, a configuration of the template T11 and a configuration of the template substrate (substrate, portion) which is the substrate before the template T11 is formed are described. FIG. 2 is a view for illustrating a method of forming the template substrate.

A template substrate Sx is a plate-shaped member formed of a template material (glass material such as quartz). The template T11 is obtained by forming the template pattern (uneven pattern) on the template substrate Sx. The template pattern is formed on a surface side of the template T11.

A rear surface side of an area in which the template pattern is formed (pattern forming portion) of the template substrate Sx is worked to be thin in order to fill the template pattern with the resist in a short time.

For example, counterboring is performed on the rear surface side of the template substrate Sx by rotation of a working head 30. A cylindrical hole (concave area) is formed, for example, on the rear surface side of the pattern forming portion of the template substrate Sx by the counterboring. According to this, the template material of the pattern forming portion is worked to be thin.

The pattern forming portion is formed in a central area on a surface side (first surface side) of the template substrate Sx. Therefore, the counterboring is performed in a central area on the rear surface side (side of a second surface opposed to the first surface) of the template substrate Sx. In other words, an area in which the counterboring is performed is provided on the side of the surface opposed to the surface on which the pattern forming portion is formed. A peripheral area on the rear surface side of the template substrate Sx is an area vacuum-sucked by the vacuum chuck 21. Out of the rear surface side of the template substrate Sx, the area in which the counterboring is performed is a concave portion and the peripheral area to be vacuum-sucked (hereinafter, referred to as the vacuum-sucked area) is a convex area.

The rear surface side of the pattern forming portion is ground by the working head 30, so that a ground surface is scratched. A foreign substance generated at the time of grinding might adhere on the rear surface side of the pattern forming portion. Therefore, in this embodiment, a repairing material such as a resin is applied to the rear surface side of the template substrate Sx to be cured. According to this, irregular reflection of inspection light by the scratch on the rear surface is inhibited at the time of defect inspection after the template T11 is formed of the template substrate Sx.

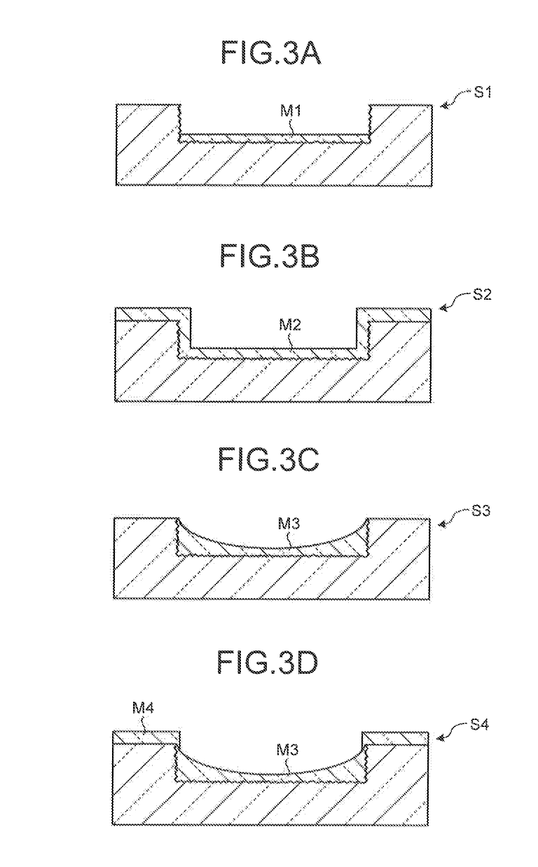

FIGS. 3A to 3D are views of cross-sectional configuration examples of the template substrates according to the embodiment. The repairing material (covering portion) such as a light transmitting material is applied to a portion in which the counterboring is performed (hereinafter, referred to as a worked portion) of the template substrate Sx. The light transmitting material is cured by a predetermined process (heating and the like).

The light transmitting material is a material which transmits light (light with a wavelength at which the resist is cured) used at the time of resist curing such as the UV light and may be any material as long as this is resistant to the light. The light transmitting material is formed of the material similar to that of the template substrate Sx, for example. In this case, a component and a composition of the material forming the light transmitting material may differ from those of the template substrate Sx.

Meanwhile, the light transmitting material may be the material different from that of the template substrate Sx as long as reflectivity of the light used at the time of the resist curing such as the UV light is substantially the same as that of the template substrate Sx. The light transmitting material may be the material with cleaning resistance or without the cleaning resistance. The light transmitting material may be an acrylic resin or a coating glass material (SOG (spin on glass) and the like), for example. The light transmitting material is formed by a process different from that of the template substrate Sx, for example.

FIG. 3A illustrates a configuration of a template substrate S1 in the case in which a light transmitting material M1 is formed on a bottom surface of the worked portion. FIG. 3B illustrates a configuration of a template substrate S2 in the case in which a light transmitting material M2 is formed on the bottom surface and a side surface of the worked portion and the vacuum-sucked area.

The light transmitting materials M1 and M2 are applied to the template substrate Sx by a spin coating method and the like, for example. At that time the template substrate Sx is rotated and the light transmitting materials M1 and M2 are dropped on a central portion of the worked portion and the like. Therefore, the light transmitting materials M1 and M2 on a periphery of the worked portion become thicker than the light transmitting materials M1 and M2 on the central portion depending on a rotational speed.

FIG. 3C illustrates a configuration of a template substrate S3 in the case in which a light transmitting material M3 is formed on the bottom surface and the side surface of the worked portion such that the periphery of the worked portion becomes thicker than the central portion FIG. 3D illustrates a configuration of a template substrate S4 in the case in which a light transmitting material M4 is further formed on the vacuum-sucked area of the template substrate S3. In this manner, the template substrate S4 has the configuration in which the light transmitting materials M3 and 134 are formed on the worked portion and the vacuum-sucked area, respectively.

In this manner, the light transmitting material on the periphery of the worked portion may have the same thickness as that on the central portion or may be thicker than that of the central portion. When the light transmitting material on the periphery of the worked portion is formed to be thicker than the light transmitting material on the central portion, a stress applied to the periphery of the worked portion becomes smaller, so that strength of the template substrates S3 and S4 is increased. Even when the foreign substance adheres to the periphery of the worked portion, this may be easily removed. Meanwhile, the light transmitting material M3 is not limited to that covering an entire side surface of the worked portion and this may be formed so as to cover a part of the side surface.

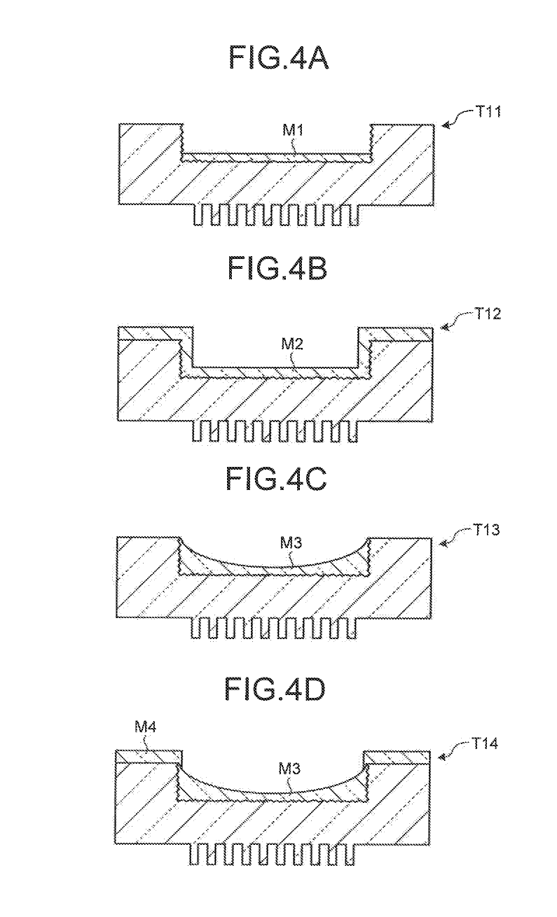

FIGS. 4A to 4D are views of cross-sectional configuration examples of the templates according to the embodiment including a mesa portion. FIGS. 4A to 4D illustrate configurations of templates T11 to T14 according to the embodiment formed of the template substrates S1 to S4, respectively.

Each of the templates T11 to T14 includes the mesa portion. In each of the templates T11 to T14, the template pattern is formed on the mesa portion. In other words, the mesa portion is formed in a pattern forming area. The mesa portion is formed of the material similar to that of the template substrate Sx, for example. In this manner, each of the templates T11 to T14 includes a first principal surface and a second principal surface and includes a convex uneven structure in which the pattern forming area of the first principal surface is higher than a surrounding area (mesa portion).

FIG. 4A illustrates the configuration of the template T11 formed of the template substrate S1 and FIG. 4B illustrates the configuration of the template T12 formed of the template substrate S2. FIG. 4C illustrates the configuration of the template T13 formed of the template substrate S3 and FIG. 4D illustrates the configuration of the template T14 formed of the template substrate S4.

In the template T11, the light transmitting material M1 is formed on the bottom surface of the worked portion. In the template 112, the light transmitting material M2 is formed on the bottom surface and the side surface of the worked portion and the vacuum-sucked area. In the template T13, the light transmitting material M3 is formed on the worked portion such that the periphery of the worked portion becomes thicker than the central portion. In the template T14, the light transmitting material M3 is formed on the worked portion such that the periphery of the worked portion becomes thicker than the central portion and the light transmitting material M4 is formed on the vacuum-sucked area.

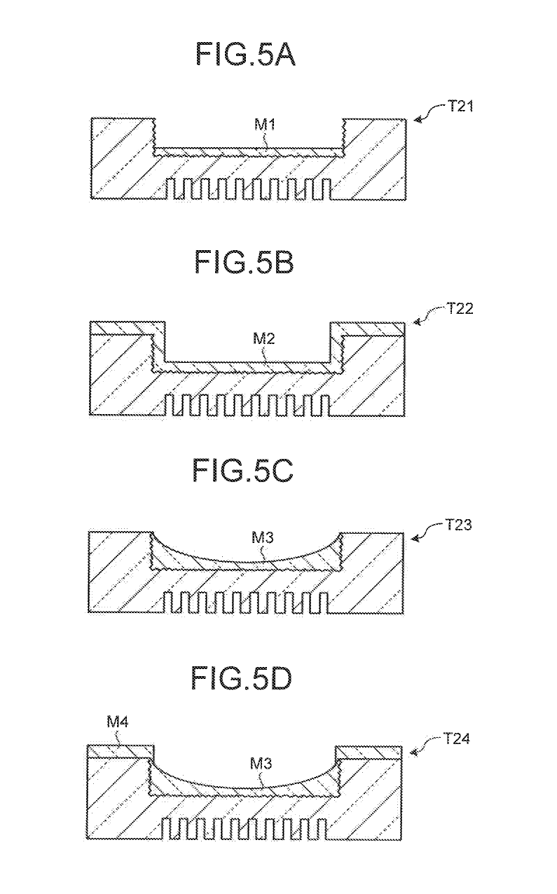

FIGS. 5A to 5D are views of cross-sectional configuration examples of the templates according to the embodiment without the mesa portion. FIGS. 5A to 5D illustrate configurations of templates T21 to T24 according to the embodiment formed of the template substrates S1 to S4, respectively.

Each of the templates T21 to T24 does not have the mesa portion and the template pattern is formed on the pattern forming portion. FIG. 5A illustrates the configuration of the template T21 formed of the template substrate S1 and FIG. 5B illustrates the configuration of the template T22 formed of the template substrate S2. FIG. 5C illustrates the configuration of the template T23 formed of the template substrate S3 and FIG. 5D illustrates the configuration of the template T24 formed of the template substrate S4.

In the template T21, the light transmitting material M1 is formed on the bottom surface of the worked portion. In the template T22, the light transmitting material M2 is formed on the worked portion and the vacuum-sucked area. In the template T23, the light transmitting material M3 is formed on the worked portion such that the periphery of the worked portion becomes thicker than the central portion. In the template T24, the light transmitting material M3 is formed on the worked portion such that the periphery of the worked portion becomes thicker than the central portion and the light transmitting material M4 is formed on the vacuum-sucked area. Meanwhile, the templates T11 to T14 and T21 to 224 are hereinafter sometimes referred to as templates TXs. The light transmitting materials M1 to M4 are sometimes referred to as light transmitting materials MXs.

A fabricating procedure of the template TX is next described. First, the fabricating procedures of the templates T11 to T14 are described and thereafter the fabricating procedures of the templates T21 to T24 are described.

Meanwhile, the templates T11 to T14 are fabricated by the similar procedures, so that the fabricating procedure of the template T11 is herein described. The templates T21 to T24 are fabricated by the similar procedures, so that the fabricating procedure of the template T21 is herein described.

Three types of fabricating procedures (first to third fabricating procedures) are hereinafter described as the fabricating procedures of the template T11 including the mesa portion. Two types of fabricating procedures (fourth and fifth fabricating procedures) are described as the fabricating procedures of due template T21 without the mesa portion.

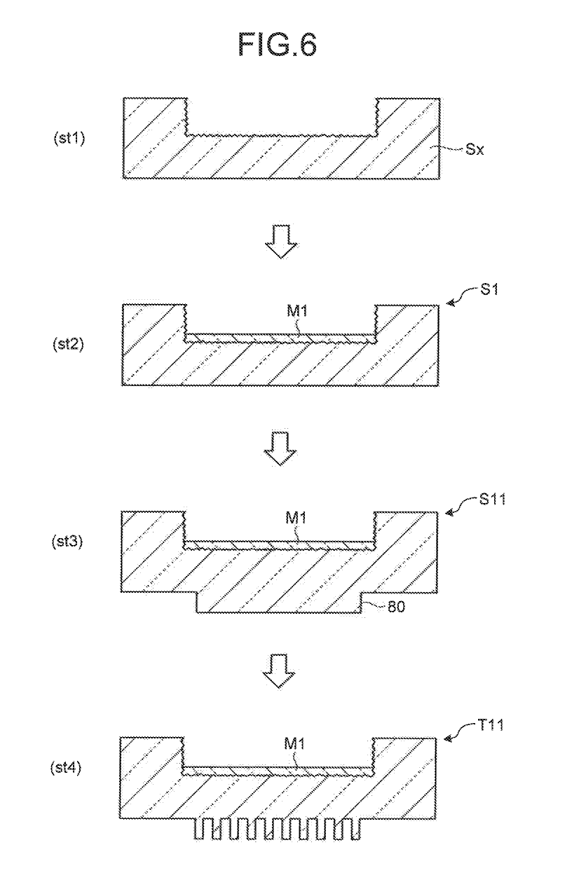

FIG. 6 is a view of the first fabricating procedure of the template. A first fabricating procedure of the template T11 including a mesa portion 80 to be described later is herein described. After the template substrate Sx is formed (st1), the light transmitting material M1 is formed on the worked portion and the template substrate S1 is formed of the template substrate Sx (st2).

Thereafter, the mesa portion 80 is formed on the template substrate S1 and the template substrate S11 is formed of the template substrate S1 (st3). Furthermore, the template pattern is formed on the mesa portion 80 of the template substrate S11 and the template T11 is formed of the template substrate S11 (st4).

Meanwhile, the mesa portion 80 may be formed by unction of a predetermined member on the template substrate Sx or may be formed by scraping off a portion other than the mesa portion 80 from the template substrate Sx.

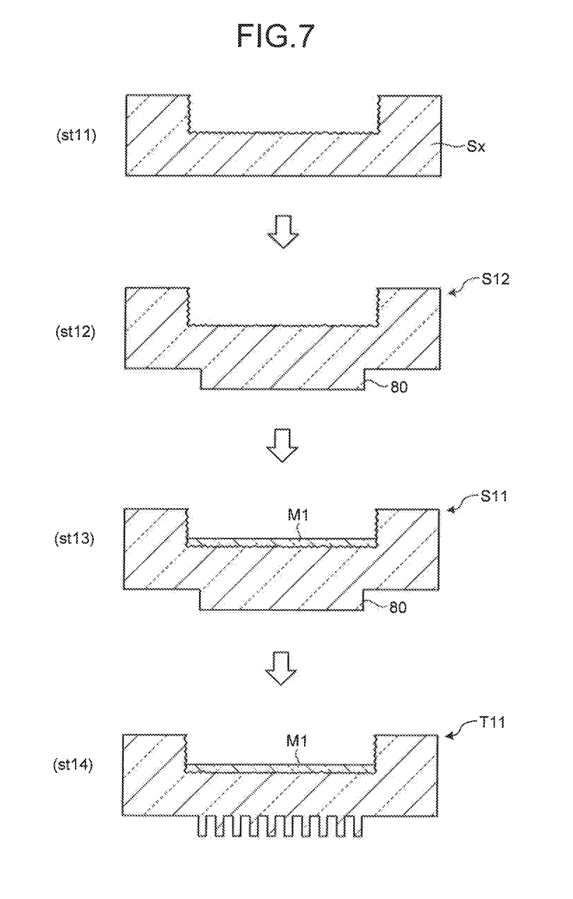

FIG. 7 is a view of the second fabricating procedure of the template. A second fabricating procedure of the template T11 including the mesa portion 80 is herein described. After the template substrate Sx is formed (st11), the mesa portion 80 is formed on the template substrate Sx and the template substrate S12 is formed of the template substrate Sx (st12).

Thereafter, the light transmitting material M1 is formed on the worked portion of the template substrate S12 and the template substrate S11 is formed of the template substrate S12 (st13). Furthermore, the template pattern is formed on the mesa portion 80 of the template substrate S11 and the template T11 is formed of the template substrate S11 (st14).

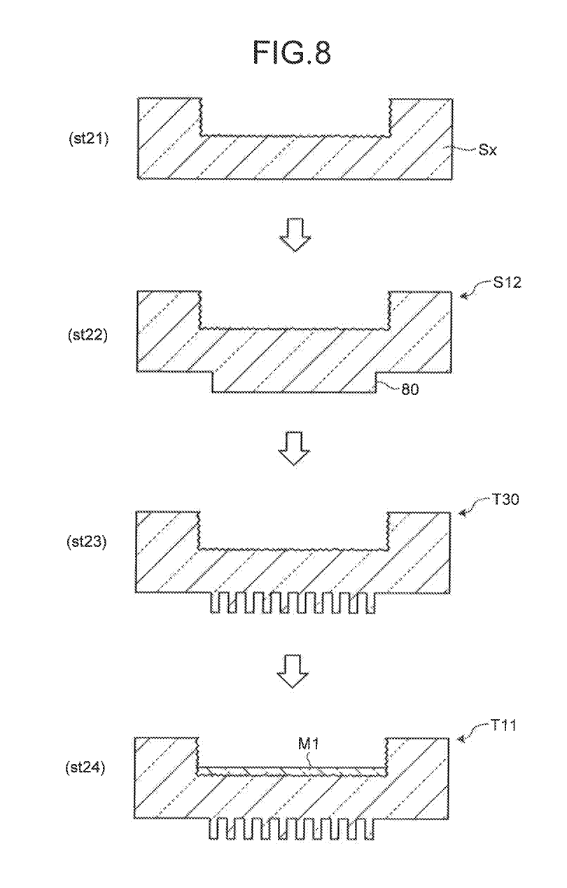

FIG. 8 is a view of the third fabricating procedure of the template. A third fabricating procedure of the template T11 including the mesa portion 80 is herein described. After the template substrate Sx is formed (st21), the mesa portion 80 is formed on the template substrate Sx and the template substrate S12 is formed of the template substrate Sx (st22).

Thereafter, the template pattern is formed on the mesa portion 80 of the template substrate S12 and a template T30 is formed of the template substrate S12 (st23). Furthermore, the light transmitting material M1 is formed on the worked portion of the template T30 and the template T11 is formed of the template T30 (st24).

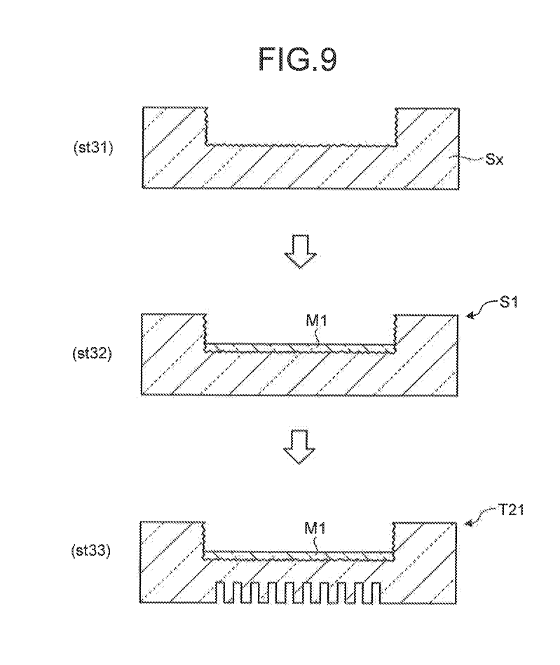

FIG. 9 is a view of the fourth fabricating procedure of the template. A first fabricating procedure of the template T21 without the mesa portion 80 is herein described. After the template substrate Sx is formed (st31), the light transmitting material M1 is formed on the worked portion and the template substrate S1 is formed of the template substrate Sx (st32). Thereafter, the template pattern is formed on the template substrate S1 and the template T21 is formed of the template substrate S1 (st33).

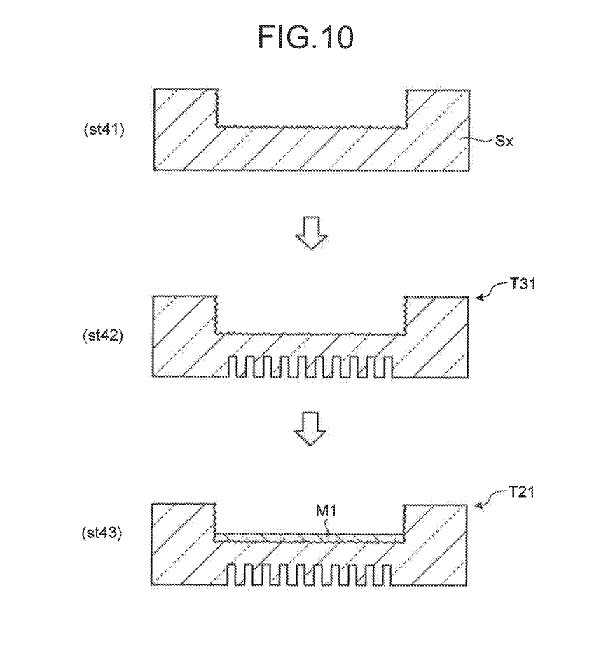

FIG. 10 is a view of the fifth fabricating procedure of the template. A second fabricating procedure of the template T21 without the mesa portion is herein described. After the template substrate Sx is formed (st41), the template pattern is formed on the template substrate Sx and a template T31 is formed from the template substrate Sx (st42). Thereafter, the light transmitting material M1 is formed on the worked portion of the template T31 and the template T21 is formed of the template T31 (st43).

The defect inspection is performed on the template TX fabricated in this manner by a defect inspecting device and the like. The template TX which passes the defect inspection is used in the imprinting process.

Meanwhile, the light transmitting material MX may be removed from the template TX after the defect inspection. In this case, the light transmitting material MX is formed on the template TX so as to be removable. A removing procedure of the light transmitting material MX is herein described. Meanwhile, the light transmitting material MX is removed from the templates T11 to T14 and T21 to T24 by the similar procedures, so that the procedure when the light transmitting material M1 is removed from the template T11 is herein described.

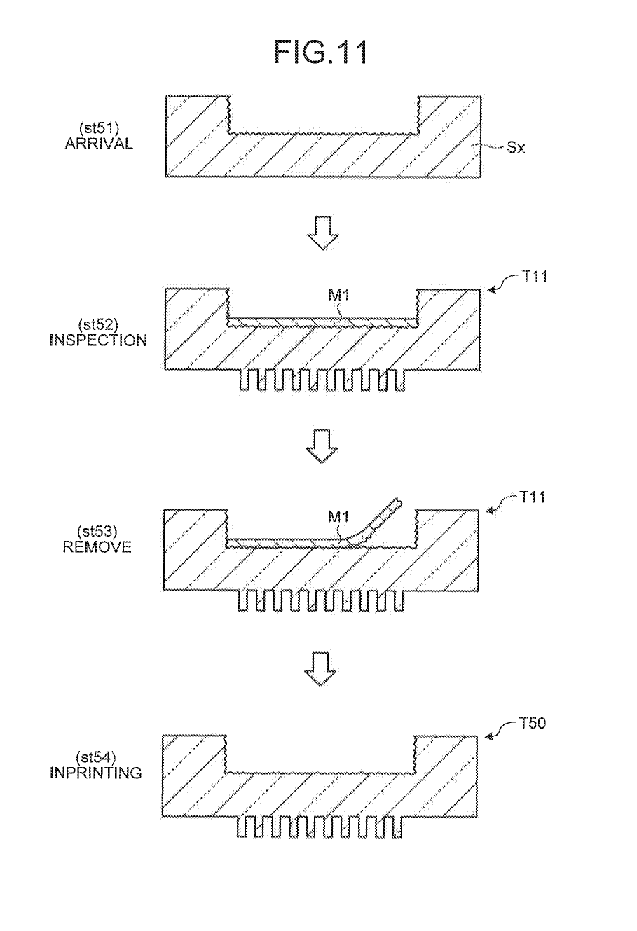

FIG. 11 is a view of the procedure when the light transmitting material is removed from the template. After arrival of the template substrate Sx (st51), the template T11 is fabricated from the template substrate Sx. The template T11 is fabricated by the above-described first to third fabricating procedures, for example. The template pattern and the light transmitting material M1 are formed on the template T11 at that time. After the template T11 is fabricated, the defect inspection is performed on the template T11 by the defect inspecting device and the like (st52).

When the template T11 is determined to pass the defect inspection, the light transmitting material M1 is removed from the template T11 (st53). The light transmitting material M1 may be removed by any method. The light transmitting material M1 may be peeled of from the template T11 or may be solved by an agent and the like, for example. The light transmitting material M1 may also be removed by a cleaning process and the like.

The light transmitting material M1 is removed from the template T11 and a template T50 is fabricated from the template T11. Thereafter, the imprinting process on the wafer Wx is executed by using the template T50 obtained by removing the light transmitting material M1 (st54).

In this manner, in the embodiment, the light transmitting material MX is formed on the rear surface of the pattern forming portion, so that this may fill the scratch on the rear surface of the pattern forming portion. According to this, the irregular reflection of the inspection light by the scratch on the rear surface may be inhibited at the time of the defect inspection of the template pattern. As a result, it becomes possible to improve defect inspection accuracy of the template pattern.

Meanwhile, the light transmitting material MX may be formed by any method such as the spin coating method and a dispensing method. The light transmitting material MX may be of any thickness. A shape of the light transmitting material MX is not limited to a film shape and this may be a shape to fill only a portion with the scratch of the worked portion and the like. The template TX may be fabricated by any procedure.

The template TX on which the light transmitting material MX is formed is fabricated for each layer of a wafer process, for example. The defect inspection is performed on the fabricated template TX and thereafter a semiconductor device (semiconductor integrated circuit) is manufactured by using the template TX which passes the inspection. Specifically, the template pattern is transferred to a product wafer to which the resist is applied by using the template TX which passes the inspection, and according to this, the resist pattern is formed on the product wafer. Thereafter, a lower layer side of the resist is etched with the resist pattern as a mask. According to this, an actual pattern corresponding to the resist pattern is formed on the product wafer. When the semiconductor device is manufactured, the imprinting process, an etching process, a film forming process and the like using the template TX are repeated for each layer.

In this manner, according to the embodiment, the light transmitting material MX is formed on the worked portion on which the counterboring is performed of the template TX and the template substrates S1 to S4, so that the irregular reflection of the inspection light in the worked portion may be inhibited at the time of the inspection of the template pattern. Therefore, it becomes possible to perform the defect inspection of the template TX with a high degree of accuracy.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A template substrate comprising:
a substrate portion formed of a first light transmitting material including a first surface on which a template pattern transferred by imprint is formed and a second surface on a surface side opposed to the first surface on which predetermined working is performed; and
a covering portion which covers at least a part of the second surface with a second light transmitting material.

2. The template substrate according to claim 1, wherein
the first and second light transmitting materials are the same materials.

3. The template substrate according to claim 1, wherein
the covering portion is formed on the second surface so as to be removable from the second surface.

4. The template substrate according to claim 1, wherein
a first area opposed to a forming area of the template pattern and a second area being an area outside the first area to be vacuum-sucked at the time of the imprint are arranged on a side of the second surface,
the first area is a concave area lower than the second area, and
the covering portion is formed on a bottom surface of the concave area.

5. The template substrate according to claim 4, wherein
the covering portion is further formed on a side surface of the concave area.

6. The template substrate according to claim 4, wherein the covering portion is further formed on the second area.

7. The template substrate according to claim 4, wherein
the covering portion is formed such that a periphery of the bottom surface of the concave area becomes thicker than a central portion of the bottom surface.

8. The template substrate according to claim 1, wherein
the second light transmitting material is supplied on the second surface by a spin coating method or a dispensing method.

9. The template substrate according to claim 1, wherein
the first and second light transmitting materials are materials which transmit light with a wavelength at which an imprint resist is cured.

10. The template substrate according to claim 1, wherein
the second light transmitting material is a glass material.

11. A template comprising:
a substrate portion formed of a first light transmitting material including a template pattern transferred by imprint and a facing surface on a surface side opposed to a surface on which the template pattern is formed on which predetermined working is performed; and
a covering portion which covers at least a part of the facing surface with a second light transmitting material.

12. The template according to claim 11, wherein
the first and second light transmitting materials are the same materials.

13. The template according to claim 11, wherein
the covering portion is formed on the facing surface seas to be removable from the facing surface.

14. The template according to claim 11, wherein
a first area opposed to a forming area of the template pattern and a second area being an area outside the first area to be vacuum-sucked at the time of the imprint are arranged on a side of the facing surface,
the first area is a concave area lower than the second area, and
the covering portion is formed on a bottom surface of the concave area.

15. The template according to claim 14, wherein
the covering portion is further formed on a side surface of the concave area.

16. The template according cc claim 14, wherein
the covering portion is further formed on the second area.

17. The template according to claim 14, wherein
the covering portion is formed such that a periphery of the bottom surface of the concave area becomes thicker than a central portion of the bottom surface.

18. A method of fabricating a template substrate comprising
forming a substrate portion of a first light transmitting material, the substrate portion including a first surface on which a template pattern transferred by imprint is formed and a second surface on a surface side opposed to the first surface on which predetermined working is performed; and
covering at least a part of the second. surface with a second light transmitting material after the predetermined working is performed on the second surface.

19. The method of fabricating a template substrate according to claim. 18, comprising:
applying the second light transmitting material to at least a part of the second surface and curing the second light transmitting material when covering at least a part of the second surface.

20. The method of fabricating a template substrate according to claim 18, wherein
a first area opposed to a forming area of the template pattern and a second area being an area outside the first area to be vacuum-sucked at the time of the imprint are arranged on a side of the second surface,
the first area is a concave area lower than the second area, and
the covering portion is formed on a bottom surface of the concave area.
